(19) United States
(12) Patent Application Publication
(10) Pub. No.: US 2009/0274157 A1
(43) Pub. Date: Nov. 5, 2009

(54) METHOD AND APPARATUS FOR HIERARCHICAL ROUTING IN MULTIPROCESSOR MESH-BASED SYSTEMS

(76) Inventors: Aniruddha S. Vaidya, Mountain View, CA (US); Doddaballapur N. Jayasimha, Sunnyvale, CA (US)

Correspondence Address: PRASS LLP, C/O INTELLEVATE, LLC, P.O. BOX 52050, MINNEAPOLIS, MN, 55402, US

(21) Appl. No.: 12/113,281

(22) Filed: May 1, 2008

(51) Int. Cl. H04L 12/56

(52) U.S. Cl. 370/400

(57) ABSTRACT

A method and apparatus for hierarchical routing in mesh systems. The method may include splitting 420 a mesh network of nodes into a plurality of partitions, each partition including at least one node, dividing 430 a first partition into a plurality of rectangular regions, determining 440 a partition route from a source region to a destination region of the plurality of rectangular regions, and providing 450 a region route from a source node within one of the plurality of rectangular regions to a destination node within the same rectangular region. The method may also include routing 460 a packet from a source node within the source region to a destination node within the destination region using the partition route and the region route.

### BACKGROUND

1. Field

The present disclosure is directed to multiprocessor mesh-based systems. More particularly, the present disclosure is directed to a method and apparatus for hierarchical routing in mesh systems.

2. Introduction

Presently, it is expected that processors with several tens to hundreds of processing cores may eventually be used on single die and multi-die architectures. Two-dimensional mesh interconnect is expected to be a strong candidate as the scalable on-die communication fabric between these processing cores and other on-die processing and input and output components. These large numbers of cores are expected to be used in a partitioned manner for multiple server, compute or hosted appliances, and other usage models. Performance and fault isolation across these multiple partitions is also expected to be a requirement or a feature in such product architectures.

Rectangular partition sub-mesh geometry can be used for performance isolation. Dimension ordered routing, also known as XY routing, can be used as a routing algorithm in a 2D mesh network. However, a requirement for rectangular partition geometry can be an overly restrictive approach to partition allocation or partition management. Present partitioning methods do not allow for performance isolation of non-rectangular partition geometries. They also do not provide partition management software with options for allocation/de-allocation or resizing of partitions while still retaining the ability to provide performance or fault isolation.

Creating multiple partitions, such as groups of one or more nodes, in a two-dimensional mesh may be done in arbitrary ways. If partitions contain nodes that are not restricted to being neighboring or proximal nodes, such as containing nodes that are disconnected or disjoint nodes grouped in a logical cluster or partition, the links of the interconnect fabric can potentially be shared by multiple partitions. Unfortunately, this can result in performance or failure of nodes within a partition having the potential to impact that of other partitions. In order to provide performance or fault-isolation, excessive additional interconnect resources in the form of virtual or physical channels and associated control logic are required. There is a need for a method and apparatus for hierarchical routing in mesh systems to overcome the above-noted and other problems with prior systems.

### BRIEF DESCRIPTION OF THE DRAWINGS

In order to describe the manner in which advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of an apparatus according to one embodiment;

FIG. 2 is an illustration of examples of non-rectangular along with rectangular partitions according to one embodiment;

FIG. 3 is an exemplary illustration of a process for hierarchical routing for an O-shaped partition according to one embodiment;

FIG. 4 is an exemplary flowchart illustrating the operation of a hierarchical routing flow according to one embodiment; and

FIG. 5 is an exemplary flowchart illustrating the operation of a hierarchical routing flow according to another embodiment.

### DETAILED DESCRIPTION

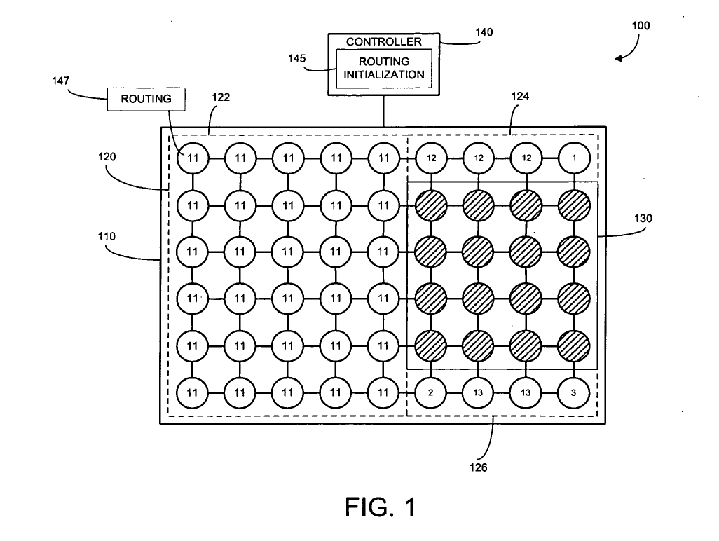

FIG. 1 is an exemplary block diagram of a system or apparatus 100 according to one embodiment. The apparatus 100 can include a mesh network 110 including a plurality of nodes. Each node can represent, for example, an interconnect router and the node may also include an optional compute element such as a processor. The apparatus 100 can also include a controller 140 coupled to the mesh network 110, the controller 140 having a routing initialization module 145. Some or all of the functions of the controller 140 and the routing initialization module 145 may be distributed among the nodes of the mesh network 110. For example, each node may include a local routing and control module 147. The controller 140 can be configured to initialize routing algorithm for each partition depending on performance isolation requirements of the partition. The routing initialization module 145 can be configured to split the mesh network 110 into a plurality of partitions 120 and 130, each partition including at least one node. For example, one partition 120 can include nodes 1, 2, 3, 11, 12, and 13. The routing initialization module 145 can divide a first partition 120 into a plurality of rectangular regions 122, 124, and 126, where the region 122 can include the nodes 11, region 124 can include the nodes 1 and 12, and the region 126 can include the nodes 2, 3, and 13. Local routing modules 147 located at each node or the routing initialization module 145 can determine a partition route from a source region 124 to a destination region 126 of the plurality of rectangular regions 120. The routing initialization module 145 or the local routing modules 147 can provide a region route from a region source node 2 within one of the plurality of rectangular regions to a region destination node 3 within the one of the plurality of rectangular regions. The local routing modules 147 or the routing initialization module 145 can route a packet from a source node 1 within the source region 124 to a destination node 3 within the destination region 126 using the partition route and the region route.

The routing initialization module 145 can split the mesh network 110 to allow for non-rectangular partitions while providing performance isolation between at least two partitions 120 and 130. The routing initialization module 145 can provide a region route by providing a region route from a source node within each of the plurality of rectangular regions 122, 124, and 126 to a destination node within each of the plurality of rectangular regions 122, 124, and 126.

The routing initialization module 145 can assign a packet with a packet destination region identifier and a packet destination node intra-region identifier. The routing initialization module 145 can assign a node with a node region identifier and a node intra-region identifier. A node of the plurality of nodes can include a routing comparison module configured to compare the packet destination region identifier with the node region identifier to determine if the packet has reached the destination region and compare the packet destination node intra-region identifier with the node region identifier to determine if the packet has reached the destination node within the destination region. The mesh network 110 nodes can be a plurality of processing cores on a single or multiple dies.

For example, sub-mesh or rectangular partition geometry can be used for performance isolation. Dimension ordered routing can be used as a routing algorithm in 2D and multi-dimensional mesh network. Dimension ordered routing in a 2D mesh network can also be called XY routing. However, a requirement for rectangular partition geometry can be an overly restrictive approach to partition allocation or partition management. The disclosed hierarchical routing approach can extend performance isolation to non-rectangular partition geometries, which can provide partition management software more options for allocation/de-allocation or resizing of partitions while still retaining the ability to provide performance or fault isolation.

Creating multiple partitions, such as groups of one or more nodes, in a two-dimensional mesh may be done in arbitrary ways. If partitions contain nodes that are not restricted to being neighboring or proximal nodes, such as containing nodes that are disconnected or disjoint nodes grouped in a logical cluster or partition, the links of the interconnect fabric can potentially be shared by multiple partitions. This may imply that performance or failure of nodes within a partition have the potential to impact that of other partitions. In order to provide performance or fault-isolation, additional interconnect resources in the form of virtual or physical channels may be needed. By requiring certain geometries of partition without restricting to rectangular geometries alone, the present disclosure can provide performance isolation without need for additional hardware complexity of several more virtual or physical channels on interconnect links.

For example, a rectangular partition can be a set of all nodes contained in a contiguous partition that are arranged in a rectangular shape, such as the partition 130. With a minimal routing algorithm, such as dimension-ordered routing like XY routing, used for internode communication in a mesh, a rectangular partition may not have “spill-over” traffic to links or routers outside of the partition. If only rectangular partitions are permitted in the apparatus 100, performance isolation across all partitions can be provided using the default routing algorithm, which may be minimal XY routing or any other minimal routing algorithm, if all partitions have rectangular geometries.

If only a given partition has a performance isolation requirement it may be possible to consider other more relaxed partitioning constraints that preserve performance isolation. Rectangular partitions may co-exist with other partitions not requiring performance isolation. Thus, it is possible to support performance isolation by requiring that other partitions be part of one of more Rectangular Group of Partitions (RGoP).

An RGoP is a set of partitions that may or may not be rectangular or contiguous but that in the aggregate have a rectangular geometry. If there are multiple RGoPs in the apparatus 100, a partition not requiring performance isolation may not span RGoPs. For example, it can be wholly contained within a single RGoP. Due to the more relaxed constraints on each individual partition that is a member of an RGoP, intra partition traffic from these could spill over to others in the same RGoP. This can be acceptable because there is no expectation of performance isolation by these member partitions. However, in the aggregate, traffic from any member partition may not spill outside the RGoP when using the same minimal routing algorithms that are used mesh-wide.

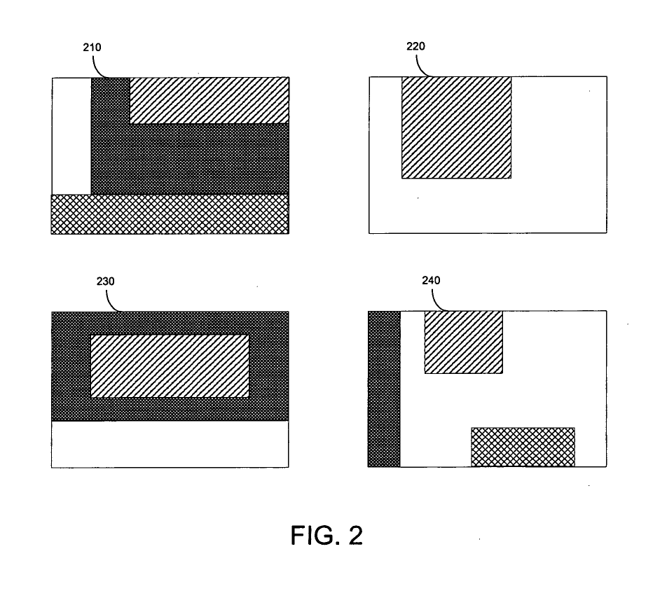

FIG. 2 is an illustration of examples of non-rectangular and rectangular partitions 210, 220, 230, and 240 according to one embodiment. Non-rectangular partitions may need to be considered for dealing with internal or external fragmentation that may be caused by strictly rectangular allocation in either static or dynamic partitioning scenarios. Fragmentation may be particularly high if there is wide variability expected in partition sizes. A partition allocation policy may be less restrictive if it permits non-rectangular partitions even if favoring rectangular partitions. When rectangular partitions are favored, non-rectangular partitions allocations may result from left-over “cookie-cutter” allocations of one or more rectangular partitions. Examples of such partitions can be C, U, E, H, L, T, etc.-shaped partitions, as shown in elements 210, 220, 230, and 240.

Performance isolation in the presence of non-rectangular partitions can require a different solution approach from previous approaches. A single global or mesh-wide routing algorithm that would suffice for performance isolation with rectangular partitions, such as partition 130, may not be adequate to ensure isolation with non-rectangular partitions, such as partition 120. Different partition specific routing algorithms may be needed to ensure that intra-partition communication in non-rectangular partitions does not spill outside that partition.

The present disclosure provides such routing algorithms in non-rectangular partitions that have reasonable performance characteristics. The present disclosure can ensure routing deadlock freedom, and better-than-worst-case performance characteristics.

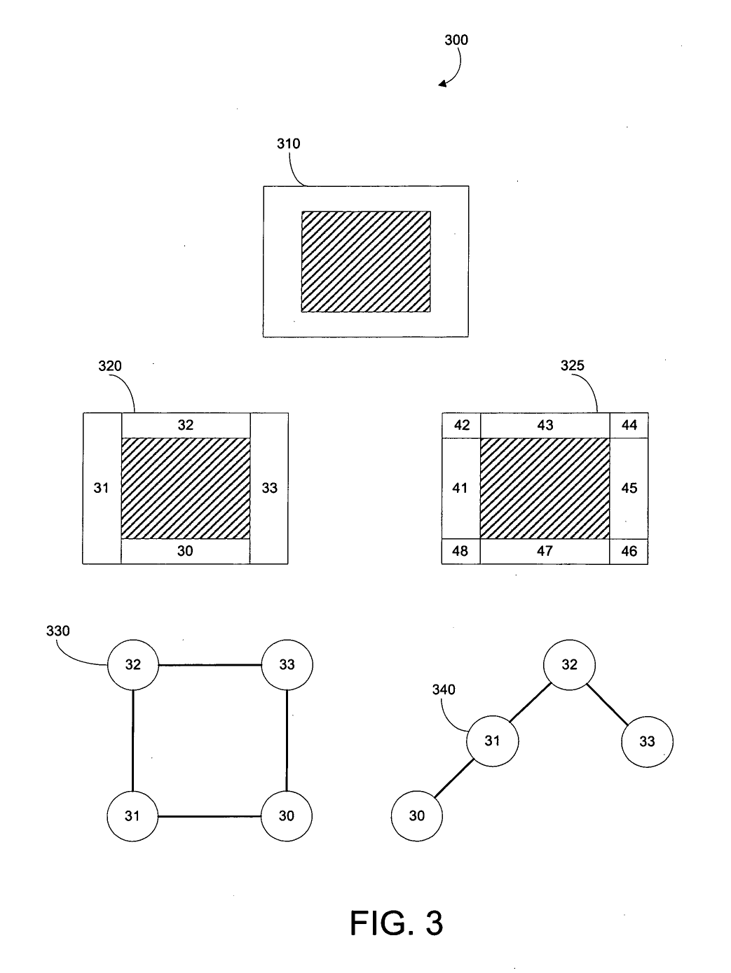

FIG. 3 is an exemplary illustration of a process 300 for hierarchical routing for an O-shaped partition according to one embodiment. A constrained non-rectangular partition can be made up of connected regions, such as rectangular components. For example an O-shaped partition 310 can be considered as four rectangles 320 arranged as a ring with each rectangle 30, 31, 32, and 33 abutting two others. Several such connected rectangular component arrangements and labelings could be conceived for any given non-rectangular partition. Such a rectangular component arrangement can be given for every non-rectangular partition for which a routing algorithm is to be constructed. As a further example, the O-shaped partition 310 can be considered as eight rectangles 325 arranged as a ring with each rectangle 41-48 abutting two others. When arranged as eight rectangular regions as shown, a packet may only need to travel in one direction, horizontal or vertical, in each region on its way to a destination region.

For hierarchical routing to construct a routing algorithm for a given non-rectangular partition, each rectangular component 30, 31, 32, and 33 can be treated as a “supernode.” Adjacent rectangular component supernodes can be connected by a “superedge.” The given non-rectangular partition can now be represented by a connected supergraph 330. A spanning-tree 340 can be created from this supergraph 330.

The hierarchical routing approach between a given source node and destination node pair can then work in two steps. In the first step, a route can take a path from the source supernode to the destination supernode that uses UP-DOWN routing in the spanning tree of the supergraph. Once the destination supernode is reached, routing to the destination node is within the same component rectangle and can use any deadlock free mesh routing algorithm. For deadlock-freedom the two hierarchical routing steps can be conducted on separate virtual networks. Each of the steps can be independently deadlock-free. Further the steps can be carried out in strict order with the first step using, for example, up-down routing and the second step using routing within destination rectangular component. Therefore, the routing algorithms designed using the hierarchical routing approach can be deadlock free because each of the steps are deadlock free and are routed on separate networks. The algorithm may be expressed as pseudo-code as follows:

// Source Node: S = Sm:Si,
// Destination Node: D = Dm:Di,
// Intermediate Node: X = Xm:Xi
// Node IDs have two parts (MeshID:IntrameshID)

| | |
|---|---|
| set X=S | // ... Xm = Sm, Xi = Si |

| | |
|---|---|
| while (X != D) | // not yet arrived at Destination |
| { | |
| if(Xm != Dm) | // Meta-level UP-DOWN routing step |
| { | |

```
    Use Extra Virtual Channel reserved for UP-DOWN routing to route
    Go from (Xm:*) 1-hop toward (Dm:*) using meta-lvl UP-DOWN
    routing step
  }
  else if( Xi != Di ) // Xm==Dm: now in Dest mesh, intra-mesh step
  {
    Use normal VCs reserved for intra-mesh routing
    Route from (Dm:Xi) 1-hop toward (Dm:Di) using mesh routing
  }
  Update X with Station Id of next hop
}
Take egress channel out to station D // now that X == D
DONE
```

A generalized hardware implementation of hierarchical routing can be possible with full routing tables at each router and one additional virtual channel per message class. With a router optimized for Dimension Ordered Routing (DOR) or XY-routing, hierarchical routing can be implemented as follows: Each node-id can be split into two separable components: a node region identifier, such as a mesh/rectangle ID and an intra-region identifier, such as an intra-mesh or intra-rectangle ID. Rectangle IDs can be partition specific. Intra-rectangle IDs can be made the same as a global node ID so that once a message reaches its destination rectangular component, it can use the baseline DOR routing to route to the destination node. This can support performance isolation using both a default DOR routing algorithm for rectangular partitions and hierarchical routing for constrained non-rectangular partitions where the node is actually extended to have a rectangle ID. An additional bit can be used to denote whether default routing or hierarchical routing is to be used for routing. Partial route tables rather than full-route tables can be used. The size of the partial route tables can be equal to the maximum number of rectangle components that are supported in the mesh interconnect. Routers within a given non-rectangular partition can be appropriately programmed with the hierarchical routing algorithm for that partition.

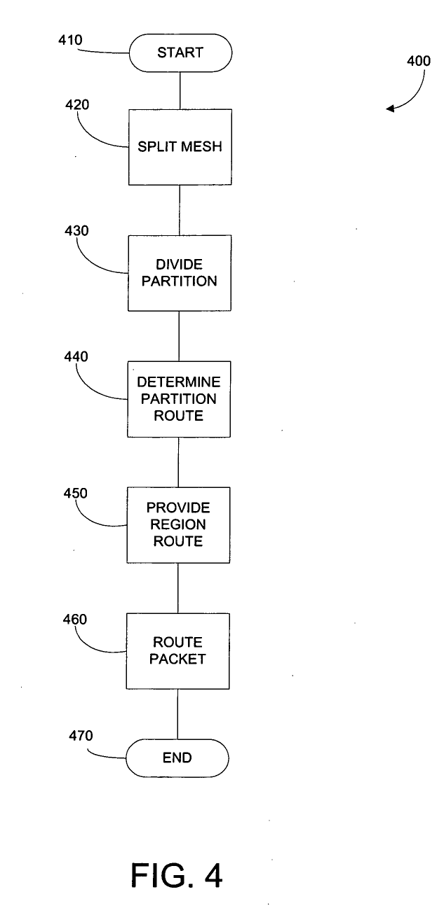

FIG. 4 is an exemplary flowchart 400 illustrating the operation of a hierarchical routing flow according to one embodiment. In block 410, the flowchart 400 begins. In block 420, the flowchart 400 can split a mesh network of nodes into a plurality of partitions, each partition including at least one node. A first partition of the plurality of partitions can provide performance isolation from a second partition of the plurality of partitions. Splitting the mesh network can allow for non-rectangular partitions while providing performance isolation between any two partitions.

In block 430, the flowchart 400 can divide a first partition into a plurality of rectangular regions. The flowchart 400 may create a tree of the plurality of rectangular regions after dividing the first partition. The plurality of rectangular regions can be a plurality of adjacent rectangular regions. In block 440, the flowchart 400 can determine a partition route from a source region to a destination region of the plurality of rectangular regions. The flowchart 400 can determine a partition route from a source region to a destination region of the plurality of rectangular regions using up-down routing.

In block 450, the flowchart 400 can provide a region route from a region source node within one of the plurality of rectangular regions to a region destination node within the same rectangular region. Providing a region route can include providing a region route from a region source node within each of the plurality of rectangular regions to a region destination node within the same rectangular region. Providing a region route can also include providing a region route from a source node within the destination region to a destination node within the destination region. In block 460, the flowchart 400 can route a packet from a source node within the source region to a destination node within the destination region using the partition route and the region route. Routing the packet can employ deadlock freedom by routing the packet from the source node within the source region to the destination node within the destination region first using a deadlock free partition route and then using a deadlock free region route. In block 470, the flowchart 400 can end.

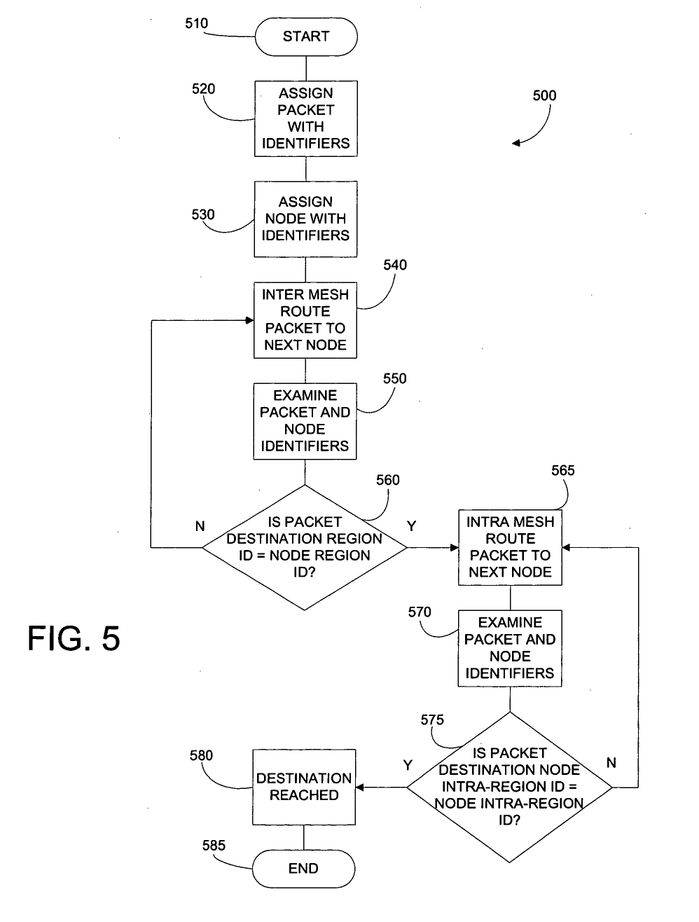

FIG. 5 is an exemplary flowchart 500 illustrating the operation of a hierarchical routing flow according to another embodiment. In block 510, the flowchart begins. In block 520, the flowchart 500 can assign a packet with both a packet destination region identifier and a packet destination node intra-region identifier. In block 530, the flowchart 500 can assign a node with both a node region identifier and an intra-region identifier. In block 540, the flowchart 500 can inter mesh route the packet to a next node on the packet's way to a destination node. In block 550, the flowchart 500 can examine the packet and node identifiers. In block 560, the flowchart 500 can compare the packet destination region identifier with the node region identifier to determine if they are equal and the packet has reached the destination region. If the packet destination region identifier and the node region identifier are not equal, the flowchart 500 can route the packet to the next node in block 540.

If the packet destination region identifier is equal to the node region identifier, in block 565, the flowchart 500 can intra mesh route the packet to the next node within the destination region. In block 570, the flowchart 500 can examine the packet and node identifiers. In block 575, the flowchart 500 can compare the packet destination node intra-region identifier with the node intra-region identifier to determine if they are equal the packet has reached the destination node within the destination region. If they are not equal, the flowchart 500 can continue routing the packet to the next node in block 565. If they are equal, in block 580 the flowchart 500 can decide the destination is reached. In block 585, the flowchart 500 can end.

Thus, among other benefits, the present disclosure can provide a solution to partitioning and performance/fault/trust isolation features in a mesh interconnect fabric. It can also be applied to partitioning and performance isolation solutions in a multi-node/multi-socket scalable multiprocessor that use a mesh interconnect. The present disclosure can use a two-level hierarchical routing algorithm for performance isolation in a 2D mesh with non-rectangular partitions. It can also enable use of non-rectangular partitions in a performance/fault isolated manner rather than a more restrictive rectangular partitions-only approach. An architectural implementation can exploit a router design optimized for XY routing. Isolation requirement can be relaxed from partitions requiring performance isolation to group of partitions requiring performance isolation and the same routing algorithm can be used. It also can be used for constrained non-rectangular partitioning.

The present disclosure can also provide a routing algorithm, such as a technique to correctly route data packets/messages from a sender node in an interconnection network to a destination node. It can relate to a routing algorithm in a two-dimensional mesh (2D-mesh) and multidimensional interconnection network.

The present disclosure can also use a routing algorithm designed for a 2D or multidimensional mesh with two or more partitions, where each partition can be a cluster of adjacent connected nodes, and to support isolation between partitions. Isolation between partitions can imply that only nodes within a partition may be required to be able to communicate with one another, such as be able to send data packets/messages. Nodes in distinct partitions do not need to communicate. Isolation can also imply an ability to confine the performance, faults, or secure domain within a partition. The shape or topology of the sub-network of each partition need not be rectangular or sub-mesh shaped. The present disclosure can reduce the constraints of partitioning or task allocation in a multi-tasking environment in a mesh that allocates tasks to smaller-sized meshes called sub-mesh allocation or rectangular allocation to simplify the task allocation, to manage the routing problem, and for isolation. The present disclosure can further provide a routing algorithm that provides isolation by confining all intra-partition communication to communication links between nodes of partitions, thereby isolating other partitions from adverse effects of performance, several types of faults, and compromised trust on another partition. The routing algorithm can provide isolation even for non-rectangular partitions in a 2D mesh. The routing algorithm can be deadlock and livelock-free and can provide performance and fault-isolation for the partition.

Each non-rectangular partition can be a composition of smaller rectangular regions that abut each other. The routing algorithm can use a two-step hierarchical approach. The first step can route from a source region, such as a smaller rectangular region, of a partition to a destination region. The second step can route within the destination rectangle to reach the desired destination node.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. For example, any minimal mesh routing algorithm can be used instead of XY routing. Also, for higher dimensions, a similar approach may be used for non-cuboid partitions in three dimensions and other partitions in higher dimensions.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method comprising:
splitting a mesh network of nodes into a plurality of partitions, each partition including at least one node;
dividing a first partition into a plurality of rectangular regions;
determining a partition route from a source region to a destination region of the plurality of rectangular regions;
providing a region route from a region source node within one of the plurality of rectangular regions to a region destination node within the same rectangular region; and
routing a packet from a source node within the source region to a destination node within the destination region using the partition route and the region route.

2. The method according to claim 1, wherein the plurality of rectangular regions comprises a plurality of adjacent rectangular regions.

3. The method according to claim 1, wherein a first partition of the plurality of partitions provides performance isolation from a second partition of the plurality of partitions.

4. The method according to claim 1, wherein splitting the mesh network allows for non-rectangular partitions while providing performance isolation between any two partitions.

5. The method according to claim 1, wherein providing a region route comprises providing a region route from a region source node within each of the plurality of rectangular regions to a region destination node within the same rectangular region.

6. The method according to claim 1, further comprising assigning a packet with both a packet destination region identifier and a packet destination node intra-region identifier.

7. The method according to claim 6, further comprising:
assigning a node with both a node region identifier and an intra-region identifier; and
comparing the packet destination region identifier with the node region identifier to determine if the packet has reached the destination region.

8. The method according to claim 7, further comprising comparing the packet destination node intra-region identifier with the node intra-region identifier to determine if the packet has reached the destination node within the destination region.

9. The method according to claim 1, further comprising:
examining a packet destination node intra-region identifier and a packet destination region identifier;
comparing the packet destination region identifier with a node region identifier to determine if the packet has reached the destination region; and
comparing, if the packet has reached the destination region, the packet destination node intra-region identifier with a node intra-region identifier to determine if the packet has reached the destination node.

10. The method according to claim 1, wherein providing a region route comprises providing a region route from a region source node within the destination region to a region destination node within the destination region.

11. The method according to claim 1, further comprising creating a tree of the plurality of rectangular regions,
wherein determining comprises determining a partition route from a source region to a destination region of the plurality of rectangular regions using an using up-down routing.

12. The method according to claim 1, wherein routing the packet employs deadlock freedom by routing the packet from the source node within the source region to the destination node within the destination region first using a deadlock free partition route and then using a deadlock free region route.

13. An apparatus comprising:
a mesh network including a plurality of nodes; and
a controller coupled to the mesh network, the controller including a routing initialization module configured to split the mesh network into a plurality of partitions, each partition including at least one node, divide a first partition into a plurality of rectangular regions; and
at least one local routing module coupled to a node of the plurality of nodes, the at least one local routing module configured to determine a partition route from a source region to a destination region of the plurality of rectangular regions, provide a region route from a region source node within one of the plurality of rectangular regions to a region destination node within the one of the plurality of rectangular regions, and route a packet from a source node within the source region to a destination node within the destination region using the partition route and the region route.

14. The apparatus according to claim 13, wherein the routing initialization module is configured to split the mesh network to allow for non-rectangular partitions while providing performance isolation between at least two partitions.

15. The apparatus according to claim 13, wherein the at least one local routing module provides a region route by providing a region route from a source node within each of the plurality of rectangular regions to a destination node within each of the plurality of rectangular regions.

16. The apparatus according to claim 13, wherein the routing initialization module is configured to assign a packet with a packet destination region identifier and a packet destination node intra-region identifier and assign a node with a node region identifier and a node intra-region identifier.

17. The apparatus according to claim 16, wherein the at least one local routing module includes a routing comparison module configured to compare the packet destination region identifier with the node region identifier to determine if the packet has reached the destination region and compare the packet destination node intra-region identifier with the node inter-identifier to determine if the packet has reached the destination node within the destination region.

18. The apparatus according to claim 13, wherein the routing initialization module is further configured to divide each of multiple partitions into a plurality of rectangular regions that have performance isolation.

19. A method comprising:
splitting a mesh network of nodes into a plurality of partitions, each partition including at least one node, at least one partition providing performance isolation from at least one other partition of the plurality of partitions;
dividing a first partition into a plurality of rectangular regions;
determining a partition route from a source region to a destination region of the plurality of rectangular regions;
providing a region route from a region source node within the destination region to a region destination node within the destination region;
examining a packet destination region identifier and a packet destination node intra-region identifier;
comparing the packet destination region identifier with a node region identifier to determine if the packet has reached the destination region; and
comparing, if the packet has reached the destination region, the packet destination node intra-region identifier with a node intra-identifier to determine if the packet has reached the destination node.

20. The method according to claim 19, wherein the plurality of partitions comprises a combination of rectangular and non-rectangular partitions.
